(19) United States
(12) Patent Application Publication
(10) Pub. No.: US 2021/0230454 A1
(43) Pub. Date: Jul. 29, 2021

(54) ADHESIVE TAPE THAT CAN BE WOUND AND STAMPED FOR SELECTIVE UV ACTIVATION

(71) Applicant: LOHMANN GMBH & CO. KG, Neuwied (DE)

(72) Inventors: Oliver KÜHL, Straßenhaus (DE); Ruben FRIEDLAND, Andernach (DE); Johannes STAHL, Koblenz (DE); Cornelia SUNDRUM, Koblenz (DE)

(73) Assignee: LOHMANN GMBH & CO. KG, Neuwied (DE)

(21) Appl. No.: 17/052,265

(22) PCT Filed: May 2, 2018
(86) PCT No.: PCT/EP2018/061236

§ 371 Date: Nov. 2, 2020

(51) Int. Cl. C09J 7/38

(52) U.S. Cl. CPC C09J 7/38; C09J 2301/416; C09J 2301/1242; C09J 2463/00

(57) ABSTRACT

An adhesive tape 10 that can be wound and stamped for selective UV activation, comprising at least a first UV activatable adhesive compound 1 on an epoxide basis and a carrier 2, the carrier being UV intransparent, for providing selective UV activatability of the adhesive tape 10.

### CROSS-REFERENCE TO RELATED APPLICATIONS

This application is a national stage U.S. patent application of International Application No. PCT/EP2018/061236, filed May 2, 2018, the entirety of which is incorporated herein by reference.

### TECHNICAL FIELD

The present invention relates to an adhesive tape that can be wound and stamped for selective UV activation, comprising at least a first UV activatable adhesive compound on an epoxide basis and a carrier, and a method for adhesive bonding of two join partners by means of the adhesive tape that can be wound and stamped.

### DESCRIPTION OF RELATED TECHNOLOGY

The terminology used in the descriptions below is to be understood as follows:

“Adhesive film” hereinafter relates to any type of spatial adhesive systems, i.e. not only adhesive tapes in the stricter sense of the word but also adhesive films, adhesive strips, adhesive plates or adhesive stamped parts.

“Pressure-sensitive adhesive” refers to adhesive bonds where the two join partners are bonded together by way of an intermediary adhesive layer and subject to pressure. The bond is reversible in that it can be released again without damaging the two join partners, because the adhesive seam is the weakest link in the adhesive bond.

“Structural” adhesive bonds are such bonds where the join partners are bonded in such a manner that, in the event of separation, the bond is not necessarily released at the adhesive seam, but that under certain circumstances also one of the join partners may constitute the weakest link in the bond, which is then damaged due to the separation. This means that structural adhesive bonds possess high strength levels. Strength levels, measured by way of a quasi-static tensile shear test are in excess of 6 MPa for structural bonds. Typical aspirational values for structural adhesive bonds of epoxy adhesives are between 10 to 20 MPa.

“Radiation curing” refers to a process where, using high-energy rays, reactive materials are conveyed from a low-molecular to a high-molecular state.

In the case in hand, UV (ultra-violet) radiation is understood to be “UV-A” or “UV-C” light.

UV-A radiation is in a wavelength range of ca. 380 to 315 nanometres (nm), UV-C radiation is in a wavelength range of ca. 280 to 100 nm. Generally, both constitute electromagnetic radiation at wavelengths shorter than visible light. For UV-A light, the energy input is ca. 3.26 to 3.95 electron volt (eV), for UV light, the energy input is ca. 4.43 to 12.40 eV.

“Activation” means that the adhesive starts curing after being exposed to UV radiation, i.e. the photo initiators included in the adhesive are activated by light radiation and trigger the curing process by initiating the formation of polymer chains. Customarily, UV curing adhesives are exposed to radiation after the join partners have been joined. For this, substrates that are sufficiently permeable for the UV radiation are used. The adhesion seam is irradiated until the curing has progressed sufficiently. It first of all is disadvantageous that impermeable substrates cannot be bonded together that way and secondly that the radiation times are relatively long.

The “opening time” or “open time” is the time between the application of the adhesive and the bonding. During the open time, for example, a liquid melt adhesive will spread across the surfaces to be bonded, thus providing for the requisite adhesion. Given that the viscosity of an adhesive generally increases after application, the open time of adhesives is limited due to time constraints.

The “curing time” is the period between the joining of the join partners and the final strength of the bond.

The term “dark reaction” consequently refers to the fact that a curing reaction is triggered by short-term radiation of the adhesive with UV light, effecting complete curing without additional radiation.

The publication W02017/174303A1 shows a radiation-activatable pressure-sensitive adhesive tape with dark reaction and its use.

According to the pressure-sensitive adhesive tapes specified above, all adhesive compounds of the pressure-sensitive adhesive tapes are activated by means UV light radiation. The application of the pressure-sensitive adhesive tapes is then limited to the open time created by the UV light radiation. Thus, the fields of application and in particular the timeframe during which the pressure-sensitive adhesive tapes can be applied, for example to join two join partners, are limited.

### SUMMARY

An object of the present disclosure is to provide an improved adhesive tape offering a wider range of application.

The object specified above is achieved by an adhesive tape utilising the features of claim 1. Advantageous further developments derive from the dependent claims.

Accordingly, an adhesive tape that can be wound and stamped for selective UV activation is provided, comprising at least a first UV activatable adhesive compound on an epoxide basis and a carrier. According to the present disclosure, the carrier is UV intransparent so as to provide for selective UV activatability of the adhesive tape.

By means of the UV intransparent carrier, the first UV activatable adhesive compound can be activated in a targeted fashion. The surface of the UV intransparent carrier facing away from the first adhesive compound is not affected by the activation, i.e. UV radiation, of the first adhesive compound. The UV treatment of the first adhesive compound can thus be dissociated from a potential UV treatment of the surface of the UV intransparent carrier facing away from the first adhesive compound.

In an embodiment, the carrier has a first surface and a second surface, whereas the first UV activatable adhesive compound is arranged on the side of the first surface of the carrier and a second adhesive compound is arranged on the side of the second surface of the carrier.

Due to the UV intransparent carrier, the curing can be executed in two stages, and respectively in a dissociated process. For example, in a symmetrical double-sided adhesive tape having a UV intransparent carrier and two UV activatable adhesive compounds of the same type, a putative user may activate the adhesive tape on one side and apply it on a first join partner without effecting activation of the second adhesive compound in the process.

In said example, the latter can be activated and attached by the final user during the shelf life of the adhesive type, including the pre-equipped first join partner.

The adhesive tape may consist in a UV intransparent carrier coated with the adhesive compound on one side (e.g. made of film, foam, paper or textile) or a UV intransparent carrier coated on two sides. In the alternative, the adhesive tape may consist in two adhesive compound layers of different types arranged on top of another, with the second adhesive compound being UV intransparent.

Moreover, the present disclosure comprises also combinations of the adhesive films specified above with other adhesive layers, such as for example pressure-sensitive adhesive or melt-adhesive layers, again equipped with a UV intransparent carrier.

Typically, also liners (release liners) are a component of adhesive tapes. Here, as a general rule, all ubiquitously known types of release liners can be used.

The processing and coating of the adhesive compound can be carried out using a solvent or hotmelt process. Also the so-called syrup technology can be used for processing and coating, where the film forming component is produced from monomers or oligomers during the coating process.

The adhesive tape is pressure-sensitive adhesive in its non-activated state and can thus be handled just like any “regular” pressure-sensitive adhesive tape, i.e. it can be applied whilst offering mild adhesion and it can also be repositioned. Stamped parts can be manufactured from the adhesive tape that can be activated by UV light prior to application on the respective parts to be bonded in order to generate a (semi-)structural bond after cross-linking.

The curing of the adhesive films and stamped parts is finally activated using UV light, preferably UV-A or UV-C light. then the join partners are finally and structurally joined. Given that the curing reaction takes place in several steps, also after activation a certain period remains during which the join partners can be finally adjusted and joined, additional activation is no longer necessary after the curing has been triggered by UV light.

The duration of the dark reaction strongly depends on different factors, such as for example the epoxy resin component used (cyclo-aliphatic or aromatic epoxy resin), the chain length, the initiator type, the radiation time, the radiation dosage (UV wavelength) or also the temperature. The curing time after radiation can amount to between 10 seconds and 60 minutes depending on the aforementioned factors and their interaction.

In a further embodiment, the second adhesive compound is identical to the first UV activatable adhesive compound. This is particularly advantageous for join partners of the same type.

In a further development, the second adhesive compound is different from the first UV activatable adhesive compound, with the second adhesive compound being UV activatable. Thus, it is possible to accommodate the requirements of two join partners exhibiting different qualities. If, for example, a first join partner has a particularly rough surface and a second join partner has a particularly smooth surface, the first adhesive compound and the second adhesive compound can be selected depending on the surface of the respective join partner.

In a further embodiment, the carrier is a UV intransparent adhesive compound. Thus, a transfer film is obtained, where the application of a second substrate on the UV intransparent adhesive compound can be dissociated from the application of a first substrate on a first adhesive compound. A UV intransparent adhesive compound is shown for example in DE 10 2012 018 076 A1. For example, the adhesive compound may consist in a bio-compatible solvent-based polyacrylate adhesive comprising a polyacrylate solution and a crosslinking solution.

In a further embodiment, the adhesive tape that can be wound and stamped exhibits an adhesive strength between 6 and 20 MPa. The adhesive strength depends on formulation details, the UV radiation dosage and the substrates to be bonded.

In an embodiment, the first UV activatable adhesive compound comprises 2-40 percent by weight of film former, 10-70 percent by weight of aromatic epoxy resins, cyclo-aliphatic epoxy resins, the cyclo-aliphatic epoxy resins not exceeding 35 percent by weight, 0.5-7 percent by weight of cationic initiators, 0-50 percent by weight of epoxidized polyether compounds, and 0-20 percent by weight of polyol, with the proportions adding up to 100%.

Curing of the adhesive compound according to the above composition can be triggered by UV radiation in the open state. After an open time of 10 seconds to 60 minutes, the adhesive compound can be joined and finally provide structural compound strength. Moreover, the adhesive compound is stable under regular conditions. This means that production and handling is possible under ambient light conditions additional UV protection. Protected against UV rays, the adhesive compound can be stored at room temperature for several months.

In yet a further development, the second adhesive compound is different from the first UV activatable adhesive compound, whereas the second adhesive compound is non non-UV activatable. Thus, the application of a second substrate on the non-UV activatable adhesive compound can be dissociated from the application of a first substrate on a first adhesive compound.

The object specified above is moreover achieved by a method for adhesive joining of two join partners using the features of claim 9. Advantageous further developments of the method derive from the dependent claims and from the present description as well as the figures.

Accordingly, a method is provided for adhesive joining of two join partners using an adhesive tape that can be wound and stamped comprising the following steps: UV activation of a first UV activatable adhesive compound of the adhesive tape that can be wound and stamped, application of the adhesive tape that can be wound and stamped by means of the activated first adhesive compound on a first join partner during the open time of the first adhesive compound, storage or transport of the first join partner and the adhesive tape that can be wound and stamped, UV activation of a second UV activatable adhesive compound of the adhesive tape that can be wound and stamped, application of the activated second adhesive compound on a second join partner during the open time of the second adhesive compound.

Due to the UV intransparent carrier, the curing can be executed in two stages, and respectively in a dissociated process. For example, in a symmetrical double-sided adhesive tape having a UV intransparent carrier and two UV activatable adhesive compounds of the same type, a putative user may activate the adhesive tape on one side and apply it on a first join partner effecting activation of the second adhesive compound in the process. In said example, the latter can be activated and attached by the final user during the shelf life of the adhesive type, including the pre-equipped first join partner.

In an embodiment, just one UV activatable adhesive compound is irradiated by means of UV radiation per application step. Thus, it is possible to first only activate one adhesive compound of the adhesive tape.

In a further development, the join partners comprise high energy surfaces, preferably metal surfaces, fibre composite surfaces and/or glass surfaces.

In yet another embodiment, the join partners comprise low energy surfaces, preferably plastic surfaces.

### BRIEF DESCRIPTION OF THE FIGURES

embodiments are illustrated in further detail by the subsequent description of the Figures. In this:

FIG. 1 schematically shows a symmetrical double-sided adhesive tape with a UV intransparent carrier and a UV activatable adhesive compound on both sides;

FIG. 2 schematically shows an asymmetrical double-sided adhesive tape with a UV intransparent carrier and a UV activatable adhesive compound and a non-UV activatable adhesive compound;

FIG. 3 schematically shows a transfer film having in a UV activatable adhesive compound and a UV intransparent adhesive compound;

FIG. 4 schematically shows a one-sided adhesive tape having a UV intransparent carrier and a UV activatable adhesive compound;

FIG. 5 schematically shows the UV activation of the first adhesive compound of FIG. 1;

FIG. 6 schematically shows the application of the UV activated first adhesive compound of FIG. 5 on a join partner during the open time;

FIG. 7 schematically shows the UV activation of the second adhesive compound on the pre-equipped join partner of FIG. 6; and

FIG. 8 schematically shows the application of the UV activated second adhesive compound of FIG. 7 on a second join partner during the open time.

### DETAILED DESCRIPTION OF EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art.

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it may. Furthermore, the phrase “in another embodiment,” “in a further embodiment,” “in a further development,” “in another development” and so on as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references.

Described hereinafter are embodiments based on the Figures. In this, identical or similar elements or elements with the same effect are referenced with identical reference numerals in the different Figures, and these elements are not repeatedly described so as to avoid redundancies.

FIG. 1 schematically shows a symmetrical configuration of a double-sided adhesive tape 10 with a UV intransparent carrier 2 and UV activatable adhesive compounds 1, 1′. The UV activatable adhesive compounds 1, 1′ may differ in terms of their composition and their mechanical properties. Any UV intransparent spatial material can be used as carrier 2.

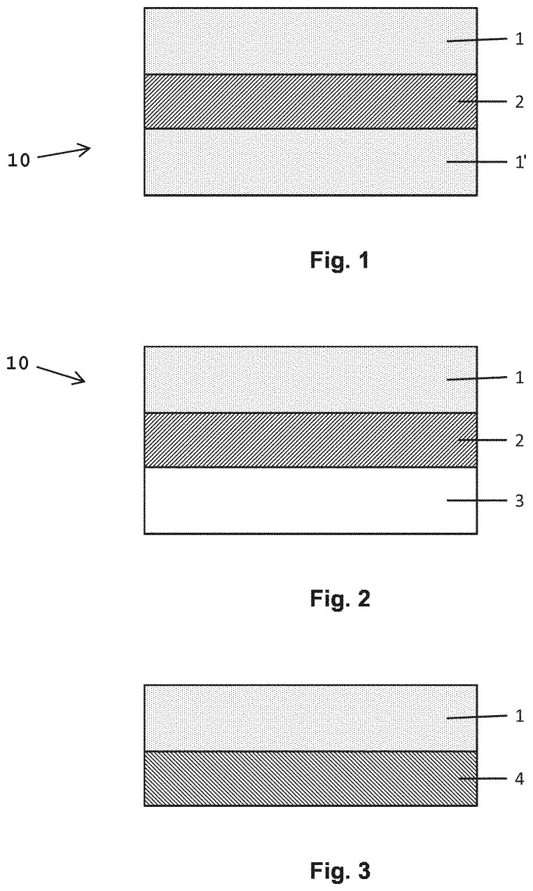

FIG. 2 schematically shows an asymmetrical configuration of a double-sided adhesive tape 10 with a UV intransparent carrier 2 and a UV activatable adhesive compound 1 and a non-UV activatable adhesive compound 3. In this context, the non-UV activatable adhesive compound 3 may for example be any type of pressure-sensitive adhesive.

FIG. 3 schematically shows a configuration for a UV intransparent adhesive compound 4 and a UV activatable adhesive compound 1. The adhesive tape can be used as a transfer film. Any pressure-sensitive adhesive compound with UV intransparent properties can be used as the UV intransparent adhesive compound 4.

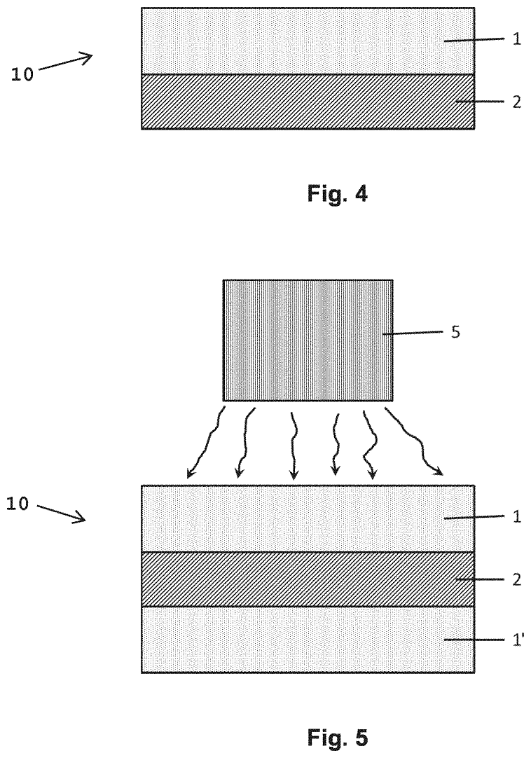

FIG. 4 schematically shows a one-sided adhesive tape 10 for a UV intransparent carrier 2 and a UV activatable adhesive compound 1.

FIG. 5 schematically shows the one-sided, i.e. selective UV activation of the symmetrical double-sided adhesive tape 10 of FIG. 1 by means of a UV radiation source 5. The UV radiation source 5 is arranged such that it irradiates only adhesive compound 1. The UV intransparent carrier prevents the UV rays reaching adhesive compound 1′, as well. Adhesive compound 1′ is thus not activated when the first adhesive compound is activated and can therefore be activated separately at a later point in time.

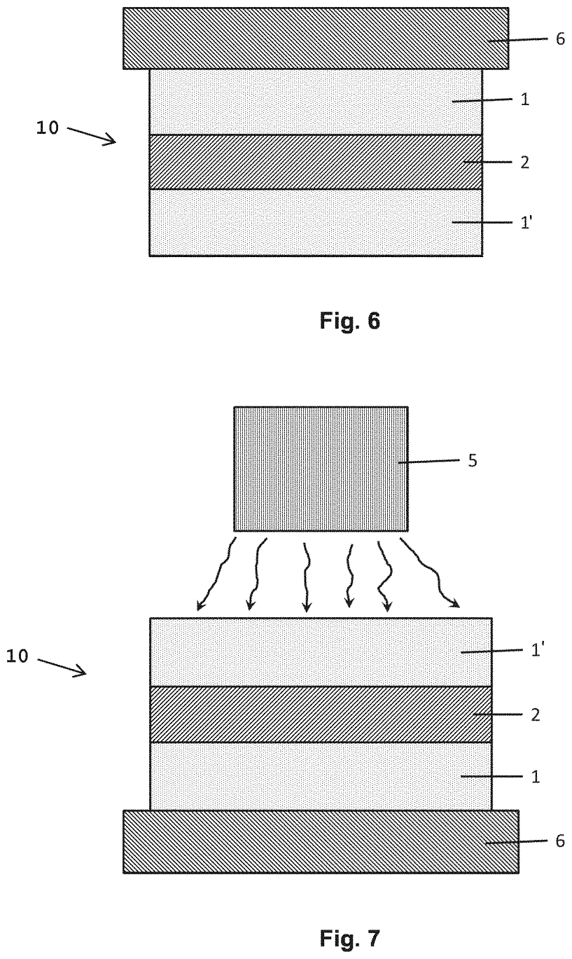

FIG. 6 schematically shows the application of the first UV activated adhesive compound 1 of adhesive tape 10 of FIG. 5 on a join partner 6. Joining takes place during the open time of the first UV activated adhesive compound 1. Subsequently, analogously, the pre-equipped join partner 6 can be stored or transported.

FIG. 7 schematically shows the adhesive tape 10 of FIG. 6 joined to the join partner 6. In particular, the UV activation state of the second UV activatable adhesive compound 1′ is shown there. Accordingly, the UV radiation source 5 is directed at the second UV activatable adhesive compound 1′.

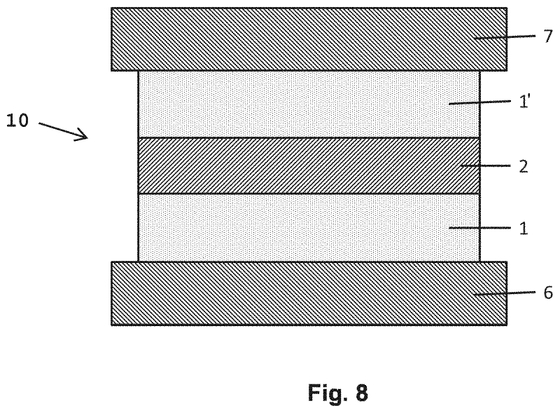

FIG. 8 schematically shows how the adhesive tape 10 of FIG. 7 is applied on a second join partner 7. In particular, the second UV activatable adhesive compound 1′ is applied on join partner 7. The joining of adhesive compound 1′ and the second join partner 7 is effected during the open time of the second UV activatable adhesive compound 1′. Following curing, the join partners 6, 7 are joined by means of the adhesive tape 10. The first join partner 6 and the second join partner 7 can be similar or different in type.

The manufacture of the adhesive tapes illustrated in the above Figures and in particular the materials used to this end for example derive from the document WO 2017/174303 A1.

For the manufacture of an adhesive tape an adhesive compound including solvents (thickness 50 μm) is applied to silicon-enhanced polyester film using a blade. Then it is dried at room temperature for 10 minutes, followed by drying in a convection oven at 80° C. for 10 minutes. The amount to be applied is adjusted such that after drying (removal of the solvent mixture) a layer thickness of 150 μm is obtained.

A pressure-sensitive adhesive (sticky) film is obtained with a thickness of ca. 150 μm.

No protective measures against UV light are necessary during handling of the raw materials, the adhesive or for the coating. It is sufficient to work under regular laboratory conditions away from the UV lamp. No further shielding is required.

Subsequently, the coated adhesive film is laminated onto a UV intransparent carrier or a UV intransparent second adhesive layer.

The pressure-sensitive adhesive film is applied to a UV intransparent carrier or a UV intransparent second adhesive layer subject to mild contact pressure. This can be achieved at a temperature of 30° C. to 40° C. (e.g. using heatable rollers) to ensure advanced applying and wetting of the pressure-sensitive adhesive UV activatable carrier. Moreover, by way of physical surface pre-treatment (plasma, corona, flame treatment, etc.), improved adhesion to the UV intransparent carrier or the second UV intransparent adhesive layer can be obtained.

The pressure-sensitive adhesive film is activated by means of UV light radiation:

In the case of an adhesive tape 10 with a symmetrical configuration according to FIG. 1 or the one-sided adhesive tape 10 according to FIG. 4, the UV activatable pressure-sensitive adhesive film (adhesive compound) 1 is activated by means of UV light from a discharging lamp or UV A light (from a UV A LED source) only on one side, i.e. the open adhesive layer. Subsequently, the pressure-sensitive adhesive film of the test-set-up of a size of ca. 312 mm² (width: 25 mm, length: 12.5 mm) is glued on to the first substrate 6 (plate made of fibre-reinforced plastic FRE, length: 100 mm, width: 25 mm, thickness: 2 mm) during the open time. In the case of a double-sided adhesive tape 10 according to FIG. 1, the radiation of the second UV activatable adhesive compound 1′ is dissociated from the above process. Hence, the radiation can be performed immediately or during the shelf life of the adhesive tape 10. After radiation of the second side, during the open time and outside of the radiation zone, the second substrate 7 is pressed onto the open adhesive film, i.e. the second adhesive compound 1′ (the adhesive film is still pressure-sensitive adhesive also after radiation) so that the two substrates 6,7 overlap and the adhesive surface amounts to 25 mm×12.5 mm. The two substrates 6,7 are fixed with braces and stored at room temperature. Tensile shear strength tests are then performed on this sample 24 hours after the second substrate 7 was joined, unless specified otherwise.

In the case of the asymmetrical configuration with the UV intransparent carrier 2 according to FIG. 2 or with the UV intransparent second adhesive layer 4 according to FIG. 3, the UV activatable adhesive compound 1 is irradiated by means of UV light and applied to a first substrate during the open time. The application of a second substrate on the non-UV activatable adhesive compound 3 and the UV intransparent adhesive compound 4, respectively, can also be dissociated from that first process step.

For UV radiation, unless specified otherwise, the LED spot 100 by the company Hönle is used. The lamp comprises a UV LED (wavelength 365 nm) and a radiation chamber. The samples are irradiated in the radiation chamber for 15 seconds. The radiation dosage, measured using a UV Power Puck II by the company EIT Instrument Market Group, amounts to 5000 mJ/cm².

Tests with a UV C lamp are carried out in a UV lab device by Beltron with a conveyor belt and a UV-C radiator with a radiation maximum at 256 nm. The conveyor belt is operated at 2m/min. The radiation dosage in the UV-C range, measured using a UV Power Puck II by the company EIT Instrument Market Group, amounts to 197 mJ/cm².

Despite the substantially higher wavelength, the adhesive compounds can also be activated using the UV LED device. Similar radiation times as in the UV-C device are feasible and the results regarding open time and adhesion strength are in the same range.

The open time is considered the maximum feasible period between the removal from the radiation belt (UV-C) or removal from the radiation chamber (UV A), respectively, and the point in time when the joining with the second substrate takes place. During this period, the join partners can be joined. It is defined such that the adhesive layer is still pressure-sensitive adhesive (tacky). The open time is determined by finger-checking the tackiness of the surface of the adhesive films after radiation. Directly after radiation, the adhesive film is still tacky. After a certain time, the degree of tangible tackiness decreases and reduces further until eventually the surface is non-tacky. The open time is determined as the point in time when tackiness tangibly decreases so that afterwards no tack remains. It turns out that as long as the surfaces are still tacky, joining is possible and the subsequent curing results in a homogeneous adhesive bond. As soon as the surfaces lose all tack, the curing process has advanced so much already that no joining is possible any longer. This is reflected in the significantly reduced strength values determined based on the quasi-static tensile shear strength. The adhesive films are joined directly after UV activation.

Test Methods

a) Quasi-Static Tensile Shear Test

In order to determine parameters for the adhesive strength on FRE, tensile shear tests are carried out according to DIN EN 1465 (2009) at 23° C.±2° C. and 50%±5% relative humidity at a testing speed of 2 mm/min. The substrates are cleaned with isopropanol and joined afterwards. The curing is achieved using UV light, and the mechanical check is performed 24 h after activation. The results are indicated in MPa (N/mm²). The figures stated are the mean value based on five measurements including standard deviation.

b) Peel Test

The peel resistance of the cured adhesive tapes on glass is determined according to DIN EN 1939 (1996) at 23° C.±2° C. and 50%±5% relative humidity at a testing speed of 100 mm/min and a peel-off angle of 90°. The samples are cured using UV light and tested 24 h after activation. The results are indicated in N/mm. The figures stated are the mean value based on five tear resistance measurements including standard deviation.

c) Tensile Test

In order to determine parameters for the strength of the adhesive film alone in its cured state, tensile tests are carried out according to DIN EN 527 (2012) at 23° C.±2° C. and 50%±5% relative humidity at a testing speed of 10 mm/min. To this end, strips of a width of 19 mm and of a length of 100 mm are cut out of cured adhesive films. In the results illustrated, the layer thickness amounts to 0.2 mm. The samples are cured using UV light and tested 24 h after activation. The results are indicated in MPa (N/mm²). The figures stated are the mean value based on five measurements including standard deviation.

The following table illustrates examples of adhesive tape configurations, whereas K1-K4 represent configurations in accordance with the present disclosure and V1 represents an adhesive transfer film UV intransparent carrier.

| Example: | K1 | K2 | K3 | K4 | V1 |
|---|---|---|---|---|---|
| Adhesive Compound (AC); | AC 1 | AC 1 | AC 2 | AC 2 | AC 2 |
| thickness: 0.15 mm | | | | | |
| Carrier (C) | C 1 | C 2 | C 1 | C 2 | — |
| Adhesive Compound (AC); | AC 1 | AC 1 | AC 2 | AC 2 | AC 2 |
| thickness: 0.15 mm | | | | | |

The following table summarises the results of the tensile shear, tensile and peel tests.

| Example: | K1 | K2 | K3 | K4 | V1 |
|---|---|---|---|---|---|
| Tensile shear | 18.6 ± 1.5 | 9.9 ± 0.7 | 23.9 ± 1.8 | 8.6 ± 1.4 | 21.8 ± 0.8 |
| strength | (AF/CSF) | (AF) | (CSF) | (AF) | (AF/CSF) |
| [MPa] | | | | | |
| Resistance to | 0.12 ± 0.03 | 0.71 ± 0.18 | 0.14 ± 0.04 | 0.79 ± 0.11 | 0.11 ± 0.02 |
| peel [N/mm] | (AF) | (AF) | (AF) | (AF) | (AF) |
| Tensile | 34.6 ± 1.2 | 9.1 ± 1.3 | 30.6 ± 2.1 | 10.1 ± 1.1 | 11.8 ± 2.4 |
| strength | | | | | |
| [MPa] | | | | | |

Key: AF: Adhesion Failure; CF: cohesive join partner failure

Adhesive films K1 and K2 as well as K3, KV and V1 all feature the same UV activatable adhesive compounds. Only the respective carrier was varied to illustrate differences in the selection of the carrier.

The adhesive films according to K1, K3 and V1 are not significantly different in terms of tensile shear strength and peel resistance within the range of the standard deviation. Here, the impact of the carrier is not very dominant in comparison to a transfer film. The tensile strength results present differently. There, the carrier has a decisive impact so that in the examples according to K1 and K3 the shear strength measured was much higher compared to V1.

The tensile shear strength and peel resistance values of examples K2 and K3 are not significantly different within the range of standard deviation. The tensile strength of said examples is at the same level of the transfer film according to V1.

Thus, it was possible to prove the impact of the different carrier materials. Carrier material 1 in the examples K1 and K3 increases tensile strength in comparison to reference V1, carrier material 2 in the examples K2 and K4 significantly increases peel resistance.

The following table illustrates the different activations. In example K5, the two adhesive compounds were activated and then joined in direct succession. In example K6, first the first adhesive compound was activated and joined and the second adhesive compound was activated four days later and joined with the second tensile shear substrate.

| Example: | K5 | K6 |
|---|---|---|
| Side 1: Adhesive Compound (AC); | AC 2 | AC 2 |
| thickness: 0.15 mm | | |
| Carrier (C) | C 2 | C 2 |
| Side 2: Adhesive Compound (AC); | AC 2 | AC 2 |
| thickness: 0.15 mm | | |
| Time between activation of side | 15 seconds | 4 days |
| 1 and side 2 | | |

The following table summarises the results of the tensile shear tests.

| Example: | K5 | K6 |
|---|---|---|
| Tensile shear | 8.6 ± 1.4 | 9.2 ± 1.2 |
| strength | (AF) | (AF) |
| [MPa] | | |

Key: AF: Adhesion failure; CF: cohesive join partner failure

The tensile shear strengths of the adhesive films according to K5 and K6 show no difference within the range of the standard deviation. Thus, the effectiveness of the UV intransparent carrier and the thus dissociated process chain could be validated and verified.

Insofar as applicable, all individual features illustrated in the sample embodiments can be combined and/or exchanged without leaving the scope of the present disclosure

### LIST OF REFERENCE NUMERALS

10 adhesive tape
1 First UV activatable adhesive compound
1′ Second UV activatable adhesive compound
2 UV intransparent carrier
3 Non-UV activatable adhesive compound
4 UV intransparent adhesive compound
5 UV radiation source
6 First join partner
7 Second join partner

1. An adhesive tape adapted to be wound and stamped for selective UV activation, comprising at least a first UV activatable adhesive compound on an epoxide basis and an UV intransparent carrier adapted to provide a selective UV activation of the adhesive tape.

2. The adhesive tape of claim 1, wherein the UV intransparent carrier has a first surface and a second surface; the first UV activatable adhesive compound is arranged on the side of the first surface of the UV intransparent carrier; and a second adhesive compounds is arranged on the side of the second surface of the UV intransparent carrier.

3. The adhesive tape of claim 2, wherein the second adhesive compound is identical to the first UV activatable adhesive compound.

4. The adhesive tape of claim 2, wherein the second adhesive compound is different from the first UV activatable adhesive compound, and the second adhesive compound is UV activatable.

5. The adhesive tape of claim 1, wherein the carrier is a UV intransparent adhesive compound.

6. The adhesive tape of claim 1, wherein the adhesive tape has an adhesive strength between 6 and 20 MPa.

7. The adhesive tape of claim 1, wherein the first UV activatable adhesive compound comprises:
a. 2-40 percent by weight of film former,
b. 10-70 percent by weight of aromatic epoxy resins,
c. cyclo-aliphatic epoxy resins, the cyclo-aliphatic epoxy resins not exceeding 35 percent by weight,
d. 0.5-7 percent by weight of cationic initiators,
e. 0-50 percent by weight of epoxy-enhanced polyether compounds, and
f. 0-20 percent by weight of polyol, the proportions adding up to 100%.

8. The adhesive tape of claim 2, wherein the second adhesive compound is different from the first UV activatable adhesive compound, and the second adhesive compound is non-UV activatable.

9. A method for adhesive joining of two join partners by means of an adhesive tape adapted to be wound and stamped of claim 2, the method comprising:
UV activation of a first UV activatable adhesive compound of the adhesive tape;
applying the adhesive tape with the activated first adhesive compound on a first join partner during an open time of the first adhesive compound,
storage or transport of the first join partner and the adhesive tape,
UV activation of a second UV activatable adhesive compound the adhesive tape, and
applying the activated second adhesive compound on a second join partner during an open time of the second adhesive compound.

10. The method for adhesive joining of two join partners of claim 9, wherein only one UV activatable adhesive compound per application is irradiated by means of UV radiation.

11. The method of adhesive joining of two join partners of the join partners comprise a high energy.

12. The method for adhesive joining of two join partners of claim 9, wherein the join partners comprise a low energy.

13. The method for adhesive joining of two join partners of claim 11, wherein the high energy surface comprises a high energy surface selected from the group consisting essentially of: a metal surface, a fibre composite surface, and a glass surface.

14. The method for adhesive joining of two join partners of claim 11, wherein the low energy surface comprises a plastic surface.
